(19) United States
(12) Patent Application Publication
(10) Pub. No.: US 2020/0196344 A1
(43) Pub. Date: Jun. 18, 2020

(54) UPLINK TRANSMISSION MULTIPLEXING

(71) Applicant: QUALCOMM Incorporated, San Diego, CA (US)

(72) Inventors: Linhai HE, San Diego, CA (US); Gavin Bernard HORN, La Jolla, CA (US)

(21) Appl. No.: 16/702,192

(22) Filed: Dec. 3, 2019

Related U.S. Application Data
(60) Provisional application No. 62/778,990, filed on Dec. 13, 2018.

(51) Int. Cl. H04W 72/12; H04L 1/18; H04L 5/00

(52) U.S. Cl. CPC H04W 72/1284; H04W 80/06; H04L 5/0055; H04L 1/1812

(57) ABSTRACT

Various aspects of the present disclosure generally relate to wireless communication. In some aspects, a user equipment may receive a physical layer downlink message including transport protocol data. The user equipment may multiplex an acknowledgement for the transport protocol data with hybrid automatic repeat request acknowledgement feedback for the physical layer downlink message. The user equipment may multiplex a scheduling request for an acknowledgement for the transport protocol data with hybrid automatic repeat request acknowledgement feedback for the physical layer downlink message. The user equipment may transmit the acknowledgement for the transport protocol data with the hybrid automatic repeat request acknowledgement feedback. Numerous other aspects are provided.

### CROSS-REFERENCE TO RELATED APPLICATION

This application claims priority to U.S. Provisional Patent Application No. 62/778,990, filed on Dec. 13, 2018, entitled “UPLINK TRANSMISSION MULTIPLEXING,” which is hereby expressly incorporated by reference herein.

### FIELD OF THE DISCLOSURE

Aspects of the present disclosure generally relate to wireless communication, and more particularly to techniques and apparatuses for uplink transmission multiplexing.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a user equipment (UE), may include receiving a physical layer downlink message including transport protocol data. The method may include multiplexing an acknowledgement for the transport protocol data with hybrid automatic repeat request acknowledgement feedback for the physical layer downlink message. The method may include transmitting the acknowledgement for the transport protocol data with the hybrid automatic repeat request acknowledgement feedback.

In some aspects, a UE for wireless communication may include memory and one or more processors operatively coupled to the memory. The memory and the one or more processors may be configured to receive a physical layer downlink message including transport protocol data. The memory and the one or more processors may be configured to multiplex an acknowledgement for the transport protocol data with hybrid automatic repeat request acknowledgement feedback for the physical layer downlink message. The memory and the one or more processors may be configured to transmit the acknowledgement for the transport protocol data with the hybrid automatic repeat request acknowledgement feedback.

In some aspects, a non-transitory computer-readable medium may store one or more instructions for wireless communication. The one or more instructions, when executed by one or more processors of a UE, may cause the one or more processors to receive a physical layer downlink message including transport protocol data. The one or more instructions, when executed by the one or more processors of the UE, may cause the one or more processors to multiplex an acknowledgement for the transport protocol data with hybrid automatic repeat request acknowledgement feedback for the physical layer downlink message. The one or more instructions, when executed by the one or more processors of the UE, may cause the one or more processors to transmit the acknowledgement for the transport protocol data with the hybrid automatic repeat request acknowledgement feedback.

In some aspects, an apparatus for wireless communication may include means for receiving a physical layer downlink message including transport protocol data. The apparatus may include means for multiplexing an acknowledgement for the transport protocol data with hybrid automatic repeat request acknowledgement feedback for the physical layer downlink message. The apparatus may include means for transmitting the acknowledgement for the transport protocol data with the hybrid automatic repeat request acknowledgement feedback.

In some aspects, a method of wireless communication, performed by a user equipment (UE), may include receiving a physical layer downlink message including transport protocol data. The method may include multiplexing a scheduling request for an acknowledgement for the transport protocol data with hybrid automatic repeat request acknowledgement feedback for the physical layer downlink message. The method may include transmitting the scheduling request for the acknowledgement for the transport protocol data with the hybrid automatic repeat request acknowledgement feedback.

In some aspects, a UE for wireless communication may include memory and one or more processors operatively coupled to the memory. The memory and the one or more processors may be configured to receive a physical layer downlink message including transport protocol data. The memory and the one or more processors may be configured to multiplex a scheduling request for an acknowledgement for the transport protocol data with hybrid automatic repeat request acknowledgement feedback for the physical layer downlink message. The memory and the one or more processors may be configured to transmit the scheduling request for the acknowledgement for the transport protocol data with the hybrid automatic repeat request acknowledgement feedback.

In some aspects, a non-transitory computer-readable medium may store one or more instructions for wireless communication. The one or more instructions, when executed by one or more processors of a UE, may cause the one or more processors to receive a physical layer downlink message including transport protocol data. The one or more instructions, when executed by the one or more processors of the UE, may cause the one or more processors to multiplex a scheduling request for an acknowledgement for the transport protocol data with hybrid automatic repeat request acknowledgement feedback for the physical layer downlink message. The one or more instructions, when executed by the one or more processors of the UE, may cause the one or more processors to transmit the scheduling request for the acknowledgement for the transport protocol data with the hybrid automatic repeat request acknowledgement feedback.

In some aspects, an apparatus for wireless communication may include means for receiving a physical layer downlink message including transport protocol data. The apparatus may include means for multiplexing a scheduling request for an acknowledgement for the transport protocol data with hybrid automatic repeat request acknowledgement feedback for the physical layer downlink message. The apparatus may include means for transmitting the scheduling request for the acknowledgement for the transport protocol data with the hybrid automatic repeat request acknowledgement feedback.

Aspects generally include a method, apparatus, system, computer program product, non-transitory computer-readable medium, user equipment, base station, wireless communication device, and/or processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a user equipment (UE) in a wireless communication network, in accordance with various aspects of the present disclosure.

FIG. 3A is a block diagram conceptually illustrating an example of a frame structure in a wireless communication network, in accordance with various aspects of the present disclosure.

FIG. 3B is a block diagram conceptually illustrating an example synchronization communication hierarchy in a wireless communication network, in accordance with various aspects of the present disclosure.

FIG. 4 is a block diagram conceptually illustrating an example slot format with a normal cyclic prefix, in accordance with various aspects of the present disclosure.

FIG. 5 illustrates an example logical architecture of a distributed radio access network (RAN), in accordance with various aspects of the present disclosure.

FIG. 6 illustrates an example physical architecture of a distributed RAN, in accordance with various aspects of the present disclosure.

FIG. 7 is a diagram illustrating an example of uplink transmission multiplexing, in accordance with various aspects of the present disclosure.

FIG. 8 is a diagram illustrating an example of uplink transmission multiplexing, in accordance with various aspects of the present disclosure.

FIG. 9 is a diagram illustrating an example process performed, for example, by a user equipment, in accordance with various aspects of the present disclosure.

FIG. 10 is a diagram illustrating an example process performed, for example, by a user equipment, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based at least in part on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

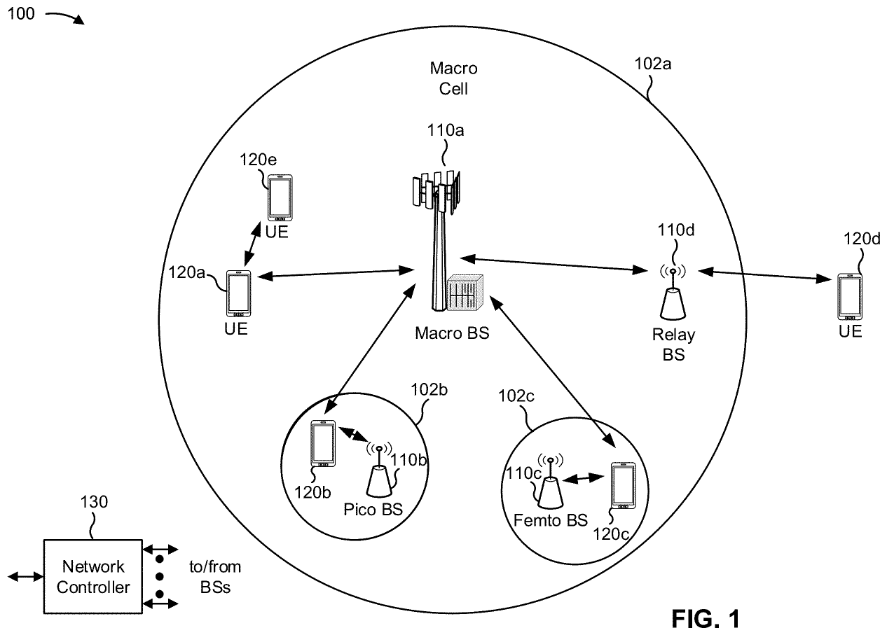

FIG. 1 is a diagram illustrating a network 100 in which aspects of the present disclosure may be practiced. The network 100 may be an LTE network or some other wireless network, such as a 5G or NR network. Wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the access network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided merely as an example. Other examples may differ from what was described with regard to FIG. 1.

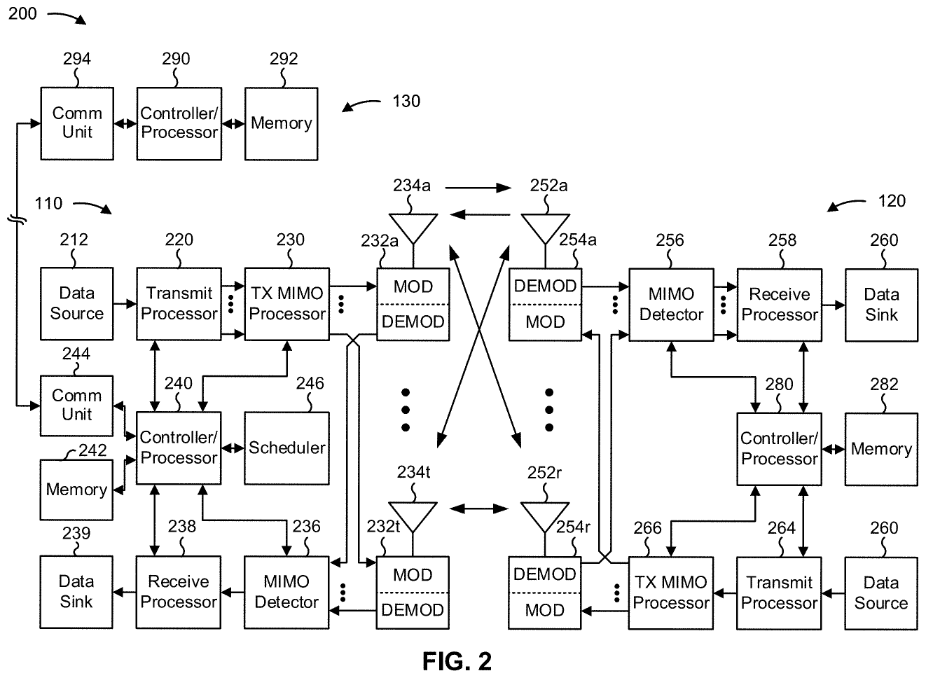

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

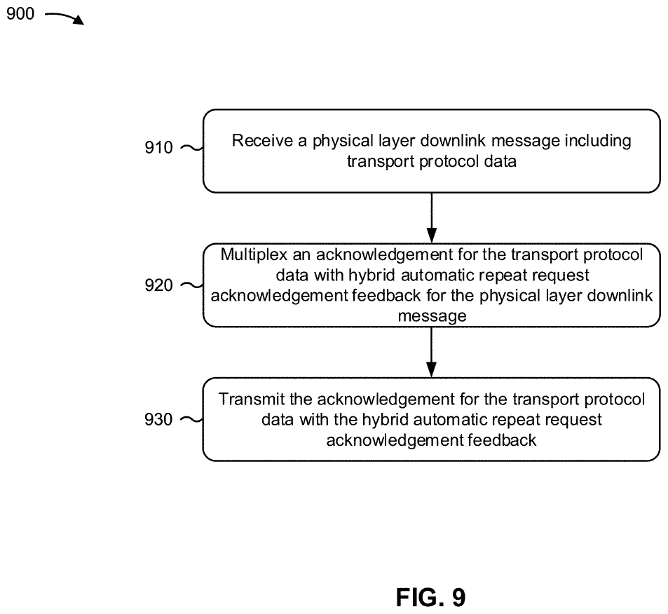

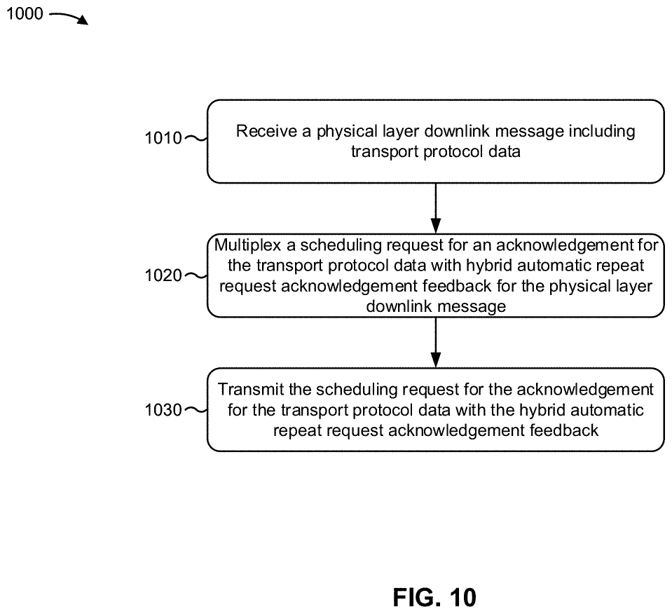

Controller/processor 240 of base station 110, controller/processor 280 of UE 120, and/or any other component(s) of FIG. 2 may perform one or more techniques associated with uplink transmission multiplexing, as described in more detail elsewhere herein. For example, controller/processor 240 of base station 110, controller/processor 280 of UE 120, and/or any other component(s) of FIG. 2 may perform or direct operations of, for example, process 900 of FIG. 9, process 1000 of FIG. 10, and/or other processes as described herein. Memories 242 and 282 may store data and program codes for base station 110 and UE 120, respectively. A scheduler 246 may schedule UEs for data transmission on the downlink and/or uplink.

In some aspects, UE 120 may include means for receiving a physical layer downlink message including transport protocol data, means for multiplexing an acknowledgement for the transport protocol data with hybrid automatic repeat request acknowledgement feedback for the physical layer downlink message, means for transmitting the acknowledgement for the transport protocol data with the hybrid automatic repeat request acknowledgement feedback, and/or the like. In some aspects, UE 120 may include means for receiving a physical layer downlink message including transport protocol data, means for multiplexing a scheduling request for an acknowledgement for the transport protocol data with hybrid automatic repeat request acknowledgement feedback for the physical layer downlink message, means for transmitting the scheduling request for the acknowledgement for the transport protocol data with the hybrid automatic repeat request acknowledgement feedback, and/or the like. In some aspects, such means may include one or more components of UE 120 described in connection with FIG. 2.

As indicated above, FIG. 2 is provided merely as an example. Other examples may differ from what was described with regard to FIG. 2.

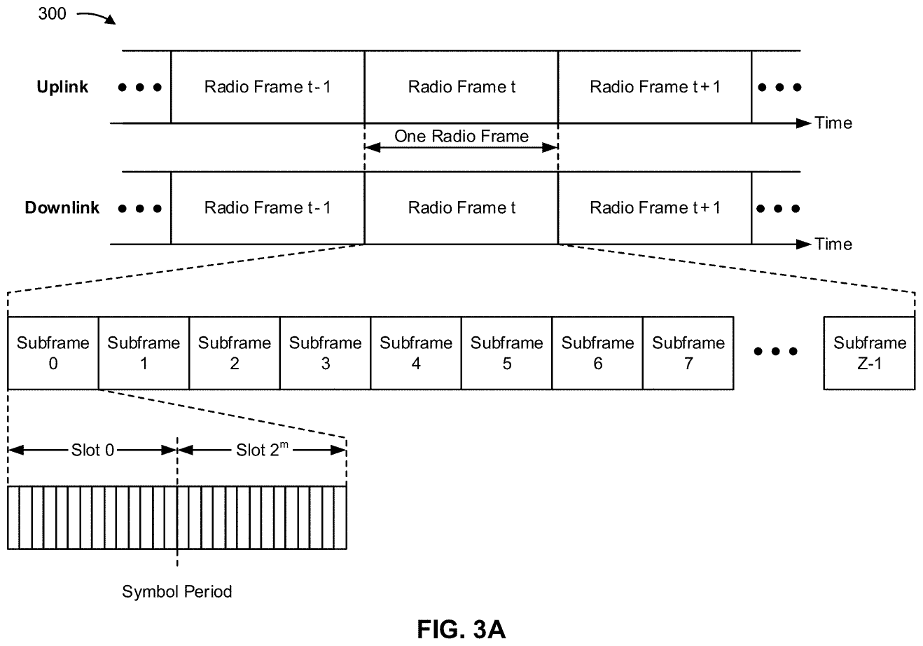

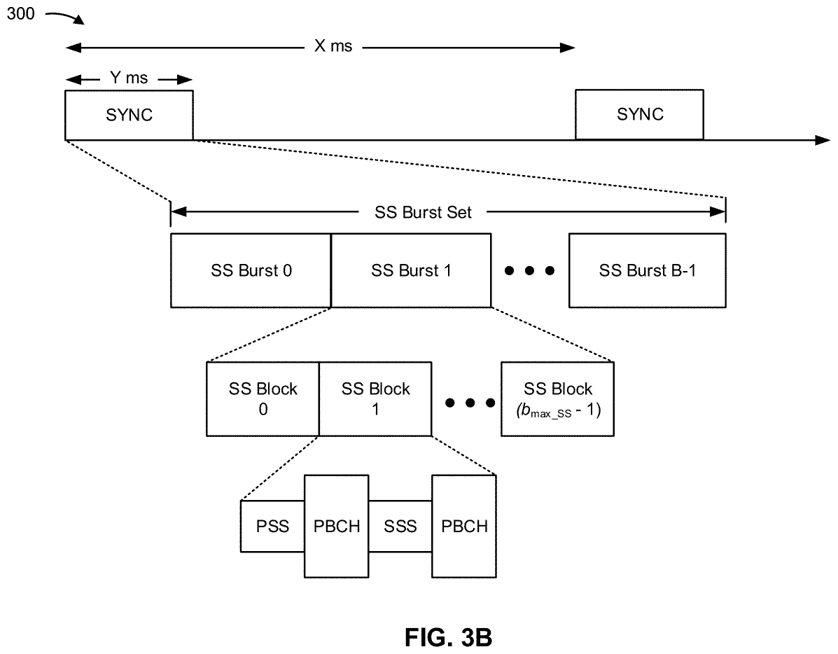

FIG. 3A shows an example frame structure 300 for FDD in a telecommunications system (e.g., NR). The transmission timeline for each of the downlink and uplink may be partitioned into units of radio frames (sometimes referred to as frames). Each radio frame may have a predetermined duration (e.g., 10 milliseconds (ms)) and may be partitioned into a set of Z (Z≥1) subframes (e.g., with indices of 0 through Z−1). Each subframe may have a predetermined duration (e.g., 1 ms) and may include a set of slots (e.g., 2^{m} slots per subframe are shown in FIG. 3A, where m is a numerology used for a transmission, such as 0, 1, 2, 3, 4, and/or the like). Each slot may include a set of L symbol periods. For example, each slot may include fourteen symbol periods (e.g., as shown in FIG. 3A), seven symbol periods, or another number of symbol periods. In a case where the subframe includes two slots (e.g., when m=1), the subframe may include 2L symbol periods, where the 2L symbol periods in each subframe may be assigned indices of 0 through 2L−1. In some aspects, a scheduling unit for the FDD may frame-based, subframe-based, slot-based, symbol-based, and/or the like.

While some techniques are described herein in connection with frames, subframes, slots, and/or the like, these techniques may equally apply to other types of wireless communication structures, which may be referred to using terms other than “frame,” “subframe,” “slot,” and/or the like in 5G NR. In some aspects, a wireless communication structure may refer to a periodic time-bounded communication unit defined by a wireless communication standard and/or protocol. Additionally, or alternatively, different configurations of wireless communication structures than those shown in FIG. 3A may be used.

In certain telecommunications (e.g., NR), a base station may transmit synchronization signals. For example, a base station may transmit a primary synchronization signal (PSS), a secondary synchronization signal (SSS), and/or the like, on the downlink for each cell supported by the base station. The PSS and SSS may be used by UEs for cell search and acquisition. For example, the PSS may be used by UEs to determine symbol timing, and the SSS may be used by UEs to determine a physical cell identifier, associated with the base station, and frame timing. The base station may also transmit a physical broadcast channel (PBCH). The PBCH may carry some system information, such as system information that supports initial access by UEs.

In some aspects, the base station may transmit the PSS, the SSS, and/or the PBCH in accordance with a synchronization communication hierarchy (e.g., a synchronization signal (SS) hierarchy) including multiple synchronization communications (e.g., SS blocks), as described below in connection with FIG. 3B.

FIG. 3B is a block diagram conceptually illustrating an example SS hierarchy, which is an example of a synchronization communication hierarchy. As shown in FIG. 3B, the SS hierarchy may include an SS burst set, which may include a plurality of SS bursts (identified as SS burst 0 through SS burst B−1, where B is a maximum number of repetitions of the SS burst that may be transmitted by the base station). As further shown, each SS burst may include one or more SS blocks (identified as SS block 0 through SS block (b_{max_SS}−1), where b_{max_SS}−1 is a maximum number of SS blocks that can be carried by an SS burst). In some aspects, different SS blocks may be beam-formed differently. An SS burst set may be periodically transmitted by a wireless node, such as every X milliseconds, as shown in FIG. 3B. In some aspects, an SS burst set may have a fixed or dynamic length, shown as Y milliseconds in FIG. 3B.

The SS burst set shown in FIG. 3B is an example of a synchronization communication set, and other synchronization communication sets may be used in connection with the techniques described herein. Furthermore, the SS block shown in FIG. 3B is an example of a synchronization communication, and other synchronization communications may be used in connection with the techniques described herein.

In some aspects, an SS block includes resources that carry the PSS, the SSS, the PBCH, and/or other synchronization signals (e.g., a tertiary synchronization signal (TSS)) and/or synchronization channels. In some aspects, multiple SS blocks are included in an SS burst, and the PSS, the SSS, and/or the PBCH may be the same across each SS block of the SS burst. In some aspects, a single SS block may be included in an SS burst. In some aspects, the SS block may be at least four symbol periods in length, where each symbol carries one or more of the PSS (e.g., occupying one symbol), the SSS (e.g., occupying one symbol), and/or the PBCH (e.g., occupying two symbols).

In some aspects, the symbols of an SS block are consecutive, as shown in FIG. 3B. In some aspects, the symbols of an SS block are non-consecutive. Similarly, in some aspects, one or more SS blocks of the SS burst may be transmitted in consecutive radio resources (e.g., consecutive symbol periods) during one or more slots. Additionally, or alternatively, one or more SS blocks of the SS burst may be transmitted in non-consecutive radio resources.

In some aspects, the SS bursts may have a burst period, whereby the SS blocks of the SS burst are transmitted by the base station according to the burst period. In other words, the SS blocks may be repeated during each SS burst. In some aspects, the SS burst set may have a burst set periodicity, whereby the SS bursts of the SS burst set are transmitted by the base station according to the fixed burst set periodicity. In other words, the SS bursts may be repeated during each SS burst set.

The base station may transmit system information, such as system information blocks (SIBs) on a physical downlink shared channel (PDSCH) in certain slots. The base station may transmit control information/data on a physical downlink control channel (PDCCH) in C symbol periods of a slot, where B may be configurable for each slot. The base station may transmit traffic data and/or other data on the PDSCH in the remaining symbol periods of each slot.

As indicated above, FIGS. 3A and 3B are provided as examples. Other examples may differ from what was described with regard to FIGS. 3A and 3B.

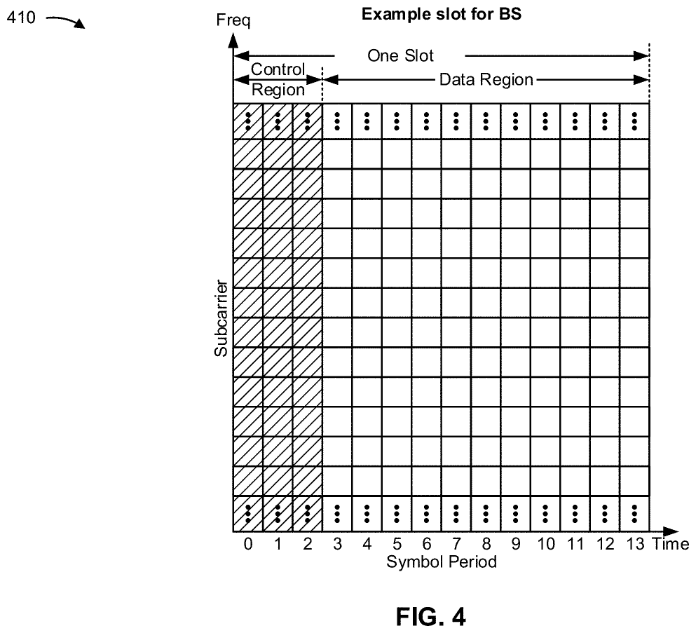

FIG. 4 shows an example slot format 410 with a normal cyclic prefix. The available time frequency resources may be partitioned into resource blocks. Each resource block may cover a set to of subcarriers (e.g., 12 subcarriers) in one slot and may include a number of resource elements. Each resource element may cover one subcarrier in one symbol period (e.g., in time) and may be used to send one modulation symbol, which may be a real or complex value.

An interlace structure may be used for each of the downlink and uplink for FDD in certain telecommunications systems (e.g., NR). For example, Q interlaces with indices of 0 through Q−1 may be defined, where Q may be equal to 4, 6, 8, 10, or some other value. Each interlace may include slots that are spaced apart by Q frames. In particular, interlace q may include slots q, q+Q, q+2Q, etc., where q∈{0, Q−1}.

A UE may be located within the coverage of multiple BSs. One of these BSs may be selected to serve the UE. The serving BS may be selected based at least in part on various criteria such as received signal strength, received signal quality, path loss, and/or the like. Received signal quality may be quantified by a signal-to-noise-and-interference ratio (SINR), or a reference signal received quality (RSRQ), or some other metric. The UE may operate in a dominant interference scenario in which the UE may observe high interference from one or more interfering BSs.

While aspects of the examples described herein may be associated with NR or 5G technologies, aspects of the present disclosure may be applicable with other wireless communication systems. New Radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). In aspects, NR may utilize OFDM with a CP (herein referred to as cyclic prefix OFDM or CP-OFDM) and/or SC-FDM on the uplink, may utilize CP-OFDM on the downlink and include support for half-duplex operation using TDD. In aspects, NR may, for example, utilize OFDM with a CP (herein referred to as CP-OFDM) and/or discrete Fourier transform spread orthogonal frequency-division multiplexing (DFT-s-OFDM) on the uplink, may utilize CP-OFDM on the downlink and include support for half-duplex operation using time division duplexing (TDD). NR may include Enhanced Mobile Broadband (eMBB) service targeting wide bandwidth (e.g., 80 megahertz (MHz) and beyond), millimeter wave (mmW) targeting high carrier frequency (e.g., 60 gigahertz (GHz)), massive MTC (mMTC) targeting non-backward compatible MTC techniques, and/or mission critical targeting ultra reliable low latency communications (URLLC) service.

In some aspects, a single component carrier bandwidth of 100 MHz may be supported. NR resource blocks may span 12 sub-carriers with a sub-carrier bandwidth of 60 or 120 kilohertz (kHz) over a 0.1 ms duration. Each radio frame may include 40 slots and may have a length of 10 ms. Consequently, each slot may have a length of 0.25 ms. Each slot may indicate a link direction (e.g., DL or UL) for data transmission and the link direction for each slot may be dynamically switched. Each slot may include DL/UL data as well as DL/UL control data.

Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based interface. NR networks may include entities such central units or distributed units.

As indicated above, FIG. 4 is provided as an example. Other examples may differ from what was described with regard to FIG. 4.

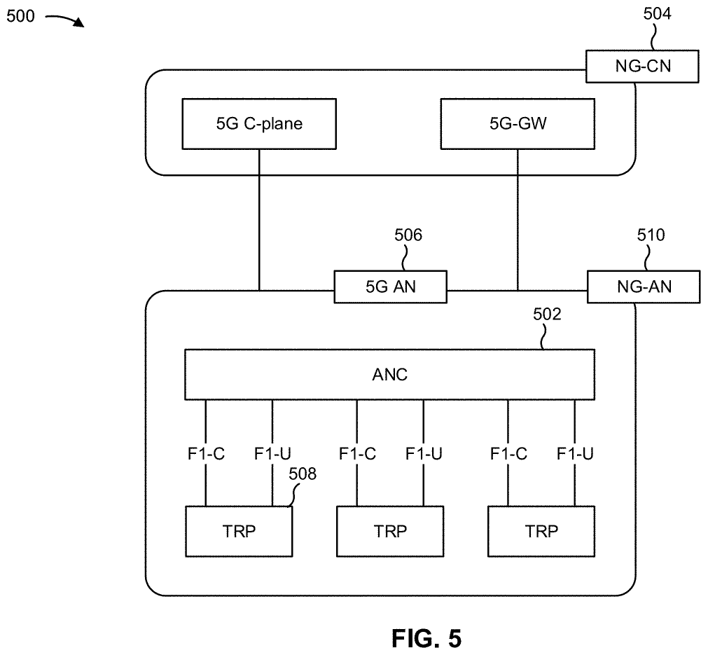

FIG. 5 illustrates an example logical architecture of a distributed RAN 500, according to aspects of the present disclosure. A 5G access node 506 may include an access node controller (ANC) 502. The ANC may be a central unit (CU) of the distributed RAN 500. The backhaul interface to the next generation core network (NG-CN) 504 may terminate at the ANC. The backhaul interface to neighboring next generation access nodes (NG-ANs) may terminate at the ANC. The ANC may include one or more TRPs 508 (which may also be referred to as BSs, NR BSs, Node Bs, 5G NBs, APs, gNB, or some other term). As described above, a TRP may be used interchangeably with “cell.”

The TRPs 508 may be a distributed unit (DU). The TRPs may be connected to one ANC (ANC 502) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of RAN 500 may be used to illustrate fronthaul definition. The architecture may be defined that support fronthauling solutions across different deployment types. For example, the architecture may be based at least in part on transmit network capabilities (e.g., bandwidth, latency, and/or jitter).

The architecture may share features and/or components with LTE. According to aspects, the next generation AN (NG-AN) 510 may support dual connectivity with NR. The NG-AN may share a common fronthaul for LTE and NR.

The architecture may enable cooperation between and among TRPs 508. For example, cooperation may be preset within a TRP and/or across TRPs via the ANC 502. According to aspects, no inter-TRP interface may be needed/present.

According to aspects, a dynamic configuration of split logical functions may be present within the architecture of RAN 500. The packet data convergence protocol (PDCP), radio link control (RLC), media access control (MAC) protocol may be adaptably placed at the ANC or TRP.

According to various aspects, a BS may include a central unit (CU) (e.g., ANC 502) and/or one or more distributed units (e.g., one or more TRPs 508).

As indicated above, FIG. 5 is provided merely as an example. Other examples may differ from what was described with regard to FIG. 5.

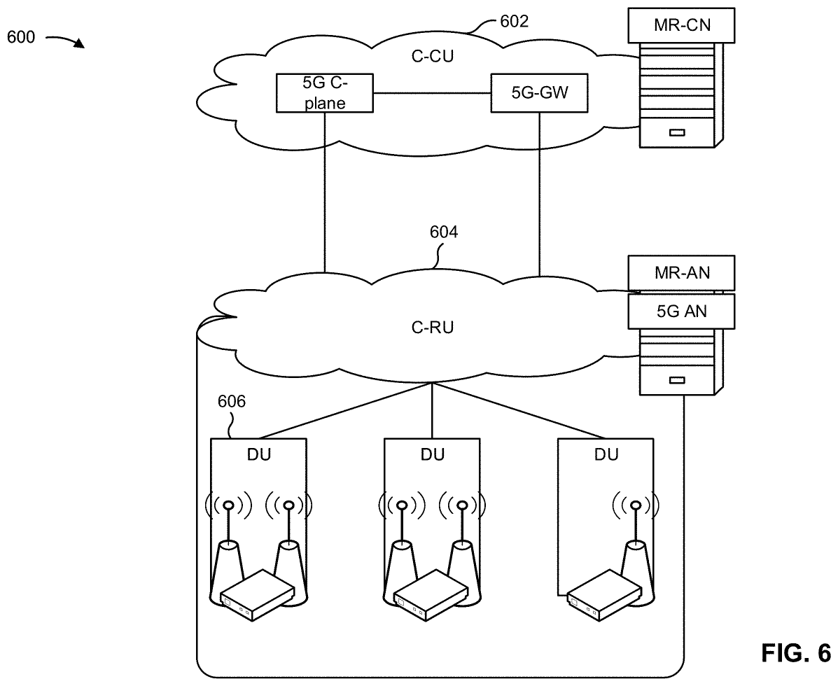

FIG. 6 illustrates an example physical architecture of a distributed RAN 600, according to aspects of the present disclosure. A centralized core network unit (C-CU) 602 may host core network functions. The C-CU may be centrally deployed. C-CU functionality may be offloaded (e.g., to advanced wireless services (AWS)), in an effort to handle peak capacity.

A centralized RAN unit (C-RU) 604 may host one or more ANC functions. Optionally, the C-RU may host core network functions locally. The C-RU may have distributed deployment. The C-RU may be closer to the network edge.

A distributed unit (DU) 606 may host one or more TRPs. The DU may be located at edges of the network with radio frequency (RF) functionality.

As indicated above, FIG. 6 is provided merely as an example. Other examples may differ from what was described with regard to FIG. 6.

In some communications systems, such as 5G or NR, a BS may use a transport protocol, such as transmission control protocol (TCP), to transmit data to a UE. For example, at an application layer of the BS, the BS may generate TCP data for transmission; at a physical layer of the BS, the BS may encapsulate the TCP data in transport blocks for a downlink transmission; and the BS may transmit the downlink transmission to convey the TCP data. A UE may receive the downlink transmission at a physical layer, and may pass the TCP data to an application layer. The UE may transmit an acknowledgement as a response. For example, the UE may transmit hybrid automatic repeat request acknowledgment (HARQ-ACK) feedback to acknowledge receipt of the downlink transmission. Similarly, the UE may transmit an acknowledgement of the TCP data (e.g., a TCP-ACK). In some cases, when the UE lacks scheduled resources for transmitting the acknowledgement of the TCP data, the UE may transmit a scheduling request, receive an uplink grant, and transmit the acknowledgement of the TCP data using the uplink grant.

However, transmitting a plurality of uplink transmissions may be resource intensive. For example, transmitting a physical uplink control channel (PUCCH) to convey a first acknowledgement and a physical uplink shared channel (PUSCH) to convey a second acknowledgement may use excessive power resources of a UE, may use excessive network resources for transmission, and/or the like. Similarly, transmitting a scheduling request to obtain an uplink grant and separately transmitting HARQ-ACK feedback may use excessive power resources, excessive network resources, and/or the like.

Some aspects described herein provide for multiplexing of uplink transmissions. For example, a UE may multiplex an acknowledgement for transport protocol data of a physical layer downlink message (e.g., a TCP-ACK) with HARQ-ACK feedback acknowledging the physical layer downlink message. Similarly, the UE may multiplex a scheduling request to obtain an uplink grant for transmitting the acknowledgement for the transport protocol data with the HARQ-ACK feedback. In this case, the UE may transmit the acknowledgement or scheduling request with a bit indicator of the acknowledgement or the scheduling request providing the HARQ-ACK feedback, thereby reducing a quantity of transmissions relative to transmitting the acknowledgement or the scheduling request separately from the HARQ-ACK feedback. In this way, the UE may reduce a utilization of power resources, a utilization of network resources, and/or the like.

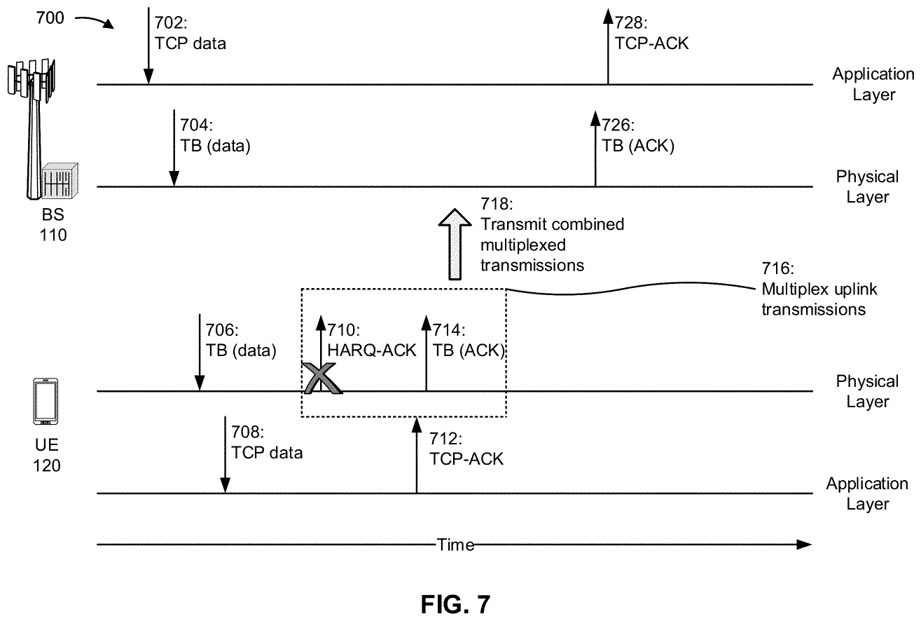

FIG. 7 is a diagram illustrating an example 700 of uplink transmission multiplexing, in accordance with various aspects of the present disclosure. As shown in FIG. 7, example 700 includes a BS 110 and a UE 120.

As further shown in FIG. 7, BS 110 and UE 120 may be associated with respective application layers and respective physical layers. As shown by reference numbers 702 and 704, BS 110 may transmit transport protocol data. For example, BS 110 may receive TCP data for transmission at the application layer, and may encapsulate the TCP data at the physical layer as a set of transport blocks conveying data (TB (data)). In this case, BS 110 may transmit a physical layer downlink message that includes the transport protocol data to UE 120.

As further shown in FIG. 7, and by reference numbers 706 and 708, UE 120 may receive the physical layer downlink message. For example, UE 120 may receive the transport blocks at the physical layer, and may receive the transport protocol data (e.g., the TCP data) at the application layer. In some aspects, receiving the physical layer downlink message may cause UE 120 to transmit a plurality of uplink messages as responses to receiving the physical layer downlink message. For example, UE 120 may determine to transmit a first acknowledgement message to indicate successful receipt of the physical layer downlink message (e.g., HARQ-ACK feedback) and a second acknowledgement message to indicate successful receipt of the transport protocol data of the physical layer downlink message (e.g., a TCP-ACK).

As further shown in FIG. 7, and by reference number 710, UE 120 may suppress transmission of the first acknowledgement message indicating successful receipt of the physical layer downlink message. For example, UE 120 may determine to delay transmission of a HARQ-ACK feedback message to enable multiplexing of the HARQ-ACK feedback with the second acknowledgement message of the transport protocol data. In some aspects, UE 120 may delay the transmission of the HARQ-ACK message for at least a threshold period of time. For example, UE 120 may set a delay timer, and may multiplex HARQ-ACK feedback for the physical layer downlink message with another uplink message associated with the physical layer downlink message before expiration of the delay timer. In some aspects, based at least in part on expiration of the delay timer, UE 120 may continue to suppress transmission of the HARQ-ACK feedback to further wait for an uplink transmission or may transmit the HARQ-ACK feedback without multiplexing the HARQ-ACK feedback with another uplink message.

As further shown in FIG. 7, and by reference number 712, UE 120 may schedule the second acknowledgement message for transmission. For example, UE 120 may determine to transmit a TCP-ACK to acknowledge receipt of the TCP data at the physical layer. In this case, UE 120 may determine that resources are available for transmission of the TCP-ACK and a scheduling request does not need to be transmitted to request an uplink grant, as described in more detail below. For example, UE 120 may determine that resources for transmission of the TCP-ACK are scheduled in a same slot as the HARQ-ACK feedback, within a threshold period of time of a scheduled transmission of the HARQ-ACK feedback, and/or the like.

As further shown in FIG. 7, and by reference numbers 714 and 716, UE 120 may multiplex the acknowledgement of the transport protocol data with the HARQ-ACK feedback. For example, UE 120 may set a bit indicator in an uplink control message conveying the TCP-ACK (shown as a TB (ACK) message) to indicate that HARQ-ACK feedback is also provided to BS 110. As shown by reference number 718, UE 120 may provide the acknowledgement for the transport protocol data with the HARQ-ACK feedback. In some aspects, UE 120 may use resources scheduled for acknowledgement for the transport protocol data (e.g., TCP-ACK resources) to transmit the TCP-ACK with the HARQ-ACK.

As further shown in FIG. 7, and by reference numbers 726 and 728, BS 110 may receive the uplink control message at the physical layer, which may include the HARQ-ACK. Further, based at least in part on receiving the uplink control message at the physical layer, BS 110 may receive the acknowledgement for the transport protocol data of the uplink message (e.g., the TCP-ACK) at the application layer. In this way, UE 120 transmits a single message to convey HARQ-ACK feedback and a TCP-ACK resulting from a same physical layer downlink message, thereby reducing a utilization of power resources relative to transmitting two separate messages to convey the HARQ-ACK feedback and the TCP-ACK for the same physical layer downlink message.

As indicated above, FIG. 7 is provided as an example. Other examples may differ from what was described with respect to FIG. 7.

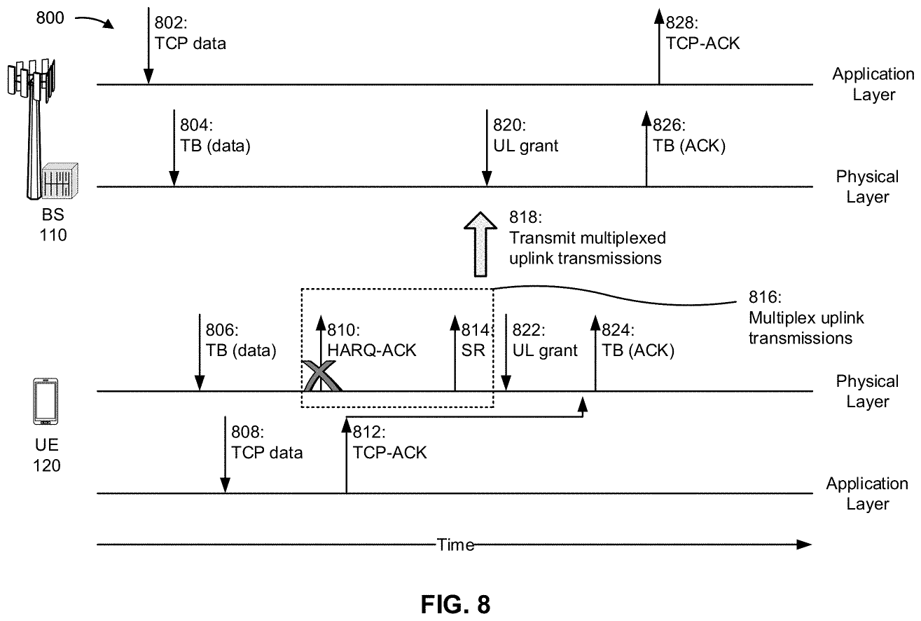

FIG. 8 is a diagram illustrating an example 800 of uplink transmission multiplexing, in accordance with various aspects of the present disclosure. As shown in FIG. 8, example 800 includes a BS 110 and a UE 120.

As further shown in FIG. 8, BS 110 and UE 120 may be associated with respective application layers and respective physical layers. As shown by reference numbers 802 and 804, BS 110 may transmit transport protocol data via a physical layer downlink message, as described in more detail above. As shown by reference numbers 806 and 808, UE 120 may receive the physical layer downlink message at the physical layer, and may receive the transport protocol data at the application layer, as described in more detail above. As shown by reference number 810, UE 120 may suppress transmission of an acknowledgement message indicating successful receipt of the physical layer downlink message, as described in more detail above. In some aspects, UE 120 may suppress the transmission based on determining that a scheduling request is to occur within a same slot as the HARQ-ACK feedback.

As further shown in FIG. 8, and by reference number 812, UE 120 may determine to transmit an acknowledgement message for the transport protocol data (e.g., a TCP-ACK), but may determine that uplink resources are not scheduled for transmitting the acknowledgement message for the transport protocol data. In this case, UE 120 may determine to delay transmission of the TCP-ACK to obtain an uplink grant to transmit the TCP-ACK.

As further shown in FIG. 8, and by reference numbers 814 and 816, UE 120 may multiplex a scheduling request (SR) for the acknowledgement of the transport protocol data with the HARQ-ACK feedback. For example, UE 120 may set a bit indicator in an uplink control message conveying a scheduling request to indicate that HARQ-ACK feedback is also provided to BS 110. As shown by reference number 818, UE 120 may provide the scheduling request with the HARQ-ACK feedback based at least in part on multiplexing the scheduling request with the HARQ-ACK feedback. In some aspects, UE 120 may provide the scheduling request with the HARQ-ACK feedback using resources scheduled for the HARQ-ACK feedback. Additionally, or alternatively, UE 120 may provide the scheduling request with the HARQ-ACK feedback using resources scheduled for the scheduling request. In some aspects, UE 120 may select, for use in transmitting a multiplexed message, first occurring resources of resources scheduling for the scheduling request and resources scheduled for the HARQ-ACK feedback. In this way, UE 120 transmits a single message to convey a HARQ-ACK feedback and a TCP-ACK, thereby reducing a utilization of power resources relative to transmitting two separate messages to convey the HARQ-ACK feedback and the TCP-ACK.

As further shown in FIG. 8, and by reference numbers 820 and 822, based at least in part on receiving the scheduling request with the HARQ-ACK feedback, BS 110 may provide an uplink grant and UE 120 may receive the uplink grant. As shown by reference numbers 824, 826, and 828, based at least in part on receiving the uplink grant, UE 120 provides an uplink message conveying the acknowledgement message for the transport protocol data to BS 110 (e.g., the TCP-ACK). In this case, BS 110 receives the uplink message at the physical layer and receives the TCP-ACK of the uplink message at the application layer, as described in more detail above.

As indicated above, FIG. 8 is provided as an example. Other examples may differ from what was described with respect to FIG. 8.

FIG. 9 is a diagram illustrating an example process 900 performed, for example, by a UE, in accordance with various aspects of the present disclosure. Example process 900 is an example where a UE (e.g., UE 120) performs uplink transmission multiplexing.

As shown in FIG. 9, in some aspects, process 900 may include receiving a physical layer downlink message including transport protocol data (block 910). For example, the UE (e.g., using antenna 252, DEMOD 254, MIMO detector 256, receive processor 258, controller/processor 280, and/or the like) may receive a physical layer downlink message including transport protocol data, as described in more detail above.

As shown in FIG. 9, in some aspects, process 900 may include multiplexing an acknowledgement for the transport protocol data with hybrid automatic repeat request acknowledgement feedback for the physical layer downlink message (block 920). For example, the UE (e.g., using controller/processor 280, transmit processor 264, TX MIMO processor 266, MOD 254, antenna 252, and/or the like) may multiplex an acknowledgement for the transport protocol data with hybrid automatic repeat request acknowledgement feedback for the physical layer downlink message, as described in more detail above.

As shown in FIG. 9, in some aspects, process 900 may include transmitting the acknowledgement for the transport protocol data with the hybrid automatic repeat request acknowledgement feedback (block 930). For example, the UE (e.g., using controller/processor 280, transmit processor 264, TX MIMO processor 266, MOD 254, antenna 252, and/or the like) may transmit the acknowledgement for the transport protocol data with the hybrid automatic repeat request acknowledgement feedback, as described in more detail above.

Process 900 may include additional aspects, such as any single aspect or any combination of aspects described below and/or in connection with one or more other processes described elsewhere herein.

With respect to process 900, in a first aspect, the UE may determine that the acknowledgement for the transport protocol data is available for multiplexing with the hybrid automatic repeat request acknowledgement feedback, and the multiplexing is based at least in part on the determining that the acknowledgement for the transport protocol data is available for multiplexing with the hybrid automatic repeat request acknowledgement feedback, and the transmitting is based at least in part on the determining that the acknowledgement for the transport protocol data with the hybrid automatic repeat request acknowledgement feedback.

With respect to process 900, in a second aspect, alone or in combination with the first aspect, the UE may determine that the acknowledgement for the transport protocol data is available for multiplexing with the hybrid automatic repeat request acknowledgement feedback during a threshold period of time. With respect to process 900, in a third aspect, alone or in combination with one or more of the first and second aspects, transmission of the hybrid automatic repeat request acknowledgement feedback is suppressed for at least a threshold period of time to multiplex the acknowledgement for the transport protocol data with the hybrid automatic repeat request acknowledgement feedback. With respect to process 900, in a fourth aspect, alone or in combination with one or more of the first through third aspects, the acknowledgement for the transport protocol data is scheduled before the hybrid automatic repeat request acknowledgement feedback is suppressed.

With respect to process 900, in a fifth aspect, alone or in combination with one or more of the first through fourth aspects, the acknowledgement for the transport protocol data is scheduled after the hybrid automatic repeat request acknowledgement feedback is suppressed and before expiration of a timer. With respect to process 900, in a sixth aspect, alone or in combination with one or more of the first through fifth aspects, the acknowledgement for the transport protocol data is transmitted with the hybrid automatic repeat request acknowledgement feedback using a resource scheduled for the acknowledgement for the transport protocol data. With respect to process 900, in a seventh aspect, alone or in combination with one or more of the first through sixth aspects, the hybrid automatic repeat request feedback and the acknowledgement for the transport protocol data are conveyed using a physical uplink shared channel.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with various aspects of the present disclosure. Example process 1000 is an example where a UE (e.g., UE 120) performs uplink transmission multiplexing.

As shown in FIG. 10, in some aspects, process 1000 may include receiving a physical layer downlink message including transport protocol data (block 1010). For example, the UE (e.g., using antenna 252, DEMOD 254, MIMO detector 256, receive processor 258, controller/processor 280, and/or the like) may receive a physical layer downlink message including transport protocol data, as described in more detail above.

As shown in FIG. 10, in some aspects, process 1000 may include multiplexing a scheduling request for an acknowledgement for the transport protocol data with hybrid automatic repeat request acknowledgement feedback for the physical layer downlink message (block 1020). For example, the UE (e.g., using controller/processor 280, transmit processor 264, TX MIMO processor 266, MOD 254, antenna 252, and/or the like) may multiplex a scheduling request for an acknowledgement for the transport protocol data with hybrid automatic repeat request acknowledgement feedback for the physical layer downlink message, as described in more detail above.

As shown in FIG. 10, in some aspects, process 1000 may include transmitting the scheduling request for the acknowledgement for the transport protocol data with the hybrid automatic repeat request acknowledgement feedback (block 1030). For example, the UE (e.g., using controller/processor 280, transmit processor 264, TX MIMO processor 266, MOD 254, antenna 252, and/or the like) may transmit the scheduling request for the acknowledgement for the transport protocol data with the hybrid automatic repeat request acknowledgement feedback, as described in more detail above.

Process 1000 may include additional aspects, such as any single aspect or any combination of aspects described below and/or in connection with one or more other processes described elsewhere herein.

With respect to process 1000, in a first aspect, the UE may determine that the scheduling request for the acknowledgement for the transport protocol data is available for multiplexing with the hybrid automatic repeat request acknowledgement feedback, and the multiplexing is based at least in part on the determining that, the scheduling request for the acknowledgement for the transport protocol data is available for multiplexing with the hybrid automatic repeat request acknowledgement feedback, and the transmitting is based at least in part on the determining that the scheduling request for the acknowledgement for the transport protocol data with the hybrid automatic repeat request acknowledgement feedback.

With respect to process 1000, in a second aspect, alone or in combination with the first aspect, the UE may determine that the scheduling request for the acknowledgement for the transport protocol data is available for multiplexing with the hybrid automatic repeat request acknowledgement feedback during a threshold period of time. With respect to process 1000, in a third aspect, alone or in combination with one or more of the first and second aspects, transmission of the hybrid automatic repeat request acknowledgement feedback is suppressed for at least a threshold period of time to multiplex the scheduling request for the acknowledgement for the transport protocol data with the hybrid automatic repeat request acknowledgement feedback. With respect to process 1000, in a fourth aspect, alone or in combination with one or more of the first through third aspects, the scheduling request for the acknowledgement for the transport protocol data is scheduled before the hybrid automatic repeat request acknowledgement feedback is suppressed.

With respect to process 1000, in a fifth aspect, alone or in combination with one or more of the first through fourth aspects, the scheduling request for the acknowledgement for the transport protocol data is scheduled after the hybrid automatic repeat request acknowledgement feedback is suppressed and before expiration of a timer. With respect to process 1000, in a sixth aspect, alone or in combination with one or more of the first through fifth aspects, the scheduling request for the acknowledgement for the transport protocol data is transmitted with the hybrid automatic repeat request acknowledgement feedback using a resource scheduled for the scheduling request for the acknowledgement for the transport protocol data. With respect to process 1000, in a seventh aspect, alone or in combination with one or more of the first through sixth aspects, the scheduling request for the acknowledgement for the transport protocol data is transmitted with the hybrid automatic repeat request acknowledgement feedback using a resource scheduled for the hybrid automatic repeat request acknowledgement feedback. With respect to process 1000, in an eighth aspect, alone or in combination with one or more of the first through seventh aspects, a physical uplink control channel format 1a message or a physical uplink control channel format 1b message is transmitted to convey the scheduling request for the acknowledgement for the transport protocol data with the hybrid automatic repeat request acknowledgement feedback.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods, described herein, may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment, comprising:
receiving a physical layer downlink message including transport protocol data;
multiplexing a scheduling request for an acknowledgement for the transport protocol data with hybrid automatic repeat request acknowledgement feedback for the physical layer downlink message; and
transmitting the scheduling request for the acknowledgement for the transport protocol data with the hybrid automatic repeat request acknowledgement feedback.

2. The method of claim 1, further comprising:
determining that the scheduling request for the acknowledgement for the transport protocol data is available for multiplexing with the hybrid automatic repeat request acknowledgement feedback,
wherein the multiplexing is based at least in part on the determining that, the scheduling request for the acknowledgement for the transport protocol data is available for multiplexing with the hybrid automatic repeat request acknowledgement feedback, and
wherein the transmitting is based at least in part on the determining that the scheduling request for the acknowledgement for the transport protocol data with the hybrid automatic repeat request acknowledgement feedback.

3. The method of claim 2, wherein the determining that the scheduling request for the acknowledgement for the transport protocol data is available for multiplexing with the hybrid automatic repeat request acknowledgement feedback, comprises:
determining that the scheduling request for the acknowledgement for the transport protocol data is available for multiplexing with the hybrid automatic repeat request acknowledgement feedback during a threshold period of time.

4. The method of claim 1, wherein transmission of the hybrid automatic repeat request acknowledgement feedback is suppressed for at least a threshold period of time to multiplex the scheduling request for the acknowledgement for the transport protocol data with the hybrid automatic repeat request acknowledgement feedback.

5. The method of claim 4, wherein the scheduling request for the acknowledgement for the transport protocol data is scheduled before the hybrid automatic repeat request acknowledgement feedback is suppressed.

6. The method of claim 4, wherein the scheduling request for the acknowledgement for the transport protocol data is scheduled after the hybrid automatic repeat request acknowledgement feedback is suppressed and before expiration of a timer.

7. The method of claim 1, wherein the scheduling request for the acknowledgement for the transport protocol data is transmitted with the hybrid automatic repeat request acknowledgement feedback using a resource scheduled for the scheduling request for the acknowledgement for the transport protocol data.

8. The method of claim 1, wherein the scheduling request for the acknowledgement for the transport protocol data is transmitted with the hybrid automatic repeat request acknowledgement feedback using a resource scheduled for the hybrid automatic repeat request acknowledgement feedback.

9. The method of claim 1, wherein a physical uplink control channel format 1a message or a physical uplink control channel format 1b message is transmitted to convey the scheduling request for the acknowledgement for the transport protocol data with the hybrid automatic repeat request acknowledgement feedback.

10. A method of wireless communication performed by a user equipment, comprising:
receiving a physical layer downlink message including transport protocol data;
multiplexing an acknowledgement for the transport protocol data with hybrid automatic repeat request acknowledgement feedback for the physical layer downlink message; and
transmitting the acknowledgement for the transport protocol data with the hybrid automatic repeat request acknowledgement feedback.

11. The method of claim 10, further comprising:
determining that the acknowledgement for the transport protocol data is available for multiplexing with the hybrid automatic repeat request acknowledgement feedback,
wherein the multiplexing is based at least in part on the determining that the acknowledgement for the transport protocol data is available for multiplexing with the hybrid automatic repeat request acknowledgement feedback, and
wherein the transmitting is based at least in part on the determining that the acknowledgement for the transport protocol data with the hybrid automatic repeat request acknowledgement feedback.

12. The method of claim 11, wherein the determining that the acknowledgement for the transport protocol data is available for multiplexing with the hybrid automatic repeat request acknowledgement feedback, comprises:
determining that the acknowledgement for the transport protocol data is available for multiplexing with the hybrid automatic repeat request acknowledgement feedback during a threshold period of time.

13. The method of claim 10, wherein transmission of the hybrid automatic repeat request acknowledgement feedback is suppressed for at least a threshold period of time to multiplex the acknowledgement for the transport protocol data with the hybrid automatic repeat request acknowledgement feedback.

14. The method of claim 13, wherein the acknowledgement for the transport protocol data is scheduled before the hybrid automatic repeat request acknowledgement feedback is suppressed.

15. The method of claim 13, wherein the acknowledgement for the transport protocol data is scheduled after the hybrid automatic repeat request acknowledgement feedback is suppressed and before expiration of a timer.

16. The method of claim 10, wherein the acknowledgement for the transport protocol data is transmitted with the hybrid automatic repeat request acknowledgement feedback using a resource scheduled for the acknowledgement for the transport protocol data.

17. The method of claim 10, wherein the hybrid automatic repeat request feedback and the acknowledgement for the transport protocol data are conveyed using a physical uplink shared channel.

18. A user equipment for wireless communication, comprising:
a memory; and
one or more processors operatively coupled to the memory, the memory and the one or more processors configured to:
receive a physical layer downlink message including transport protocol data;
multiplex a scheduling request for an acknowledgement for the transport protocol data with hybrid automatic repeat request acknowledgement feedback for the physical layer downlink message; and
transmit the scheduling request for the acknowledgement for the transport protocol data with the hybrid automatic repeat request acknowledgement feedback.

19. The user equipment of claim 18, wherein the one or more processors are further configured to:
determine that the scheduling request for the acknowledgement for the transport protocol data is available for multiplexing with the hybrid automatic repeat request acknowledgement feedback,
wherein the multiplexing is based at least in part on the determining that, the scheduling request for the acknowledgement for the transport protocol data is available for multiplexing with the hybrid automatic repeat request acknowledgement feedback, and
wherein the transmitting is based at least in part on the determining that the scheduling request for the acknowledgement for the transport protocol data with the hybrid automatic repeat request acknowledgement feedback.

20. The user equipment of claim 19, wherein the one or more processors, when determining that the scheduling request for the acknowledgement for the transport protocol data is available for multiplexing with the hybrid automatic repeat request acknowledgement feedback are to:
determine that the scheduling request for the acknowledgement for the transport protocol data is available for multiplexing with the hybrid automatic repeat request acknowledgement feedback during a threshold period of time.

21. The user equipment of claim 18, wherein transmission of the hybrid automatic repeat request acknowledgement feedback is suppressed for at least a threshold period of time to multiplex the scheduling request for the acknowledgement for the transport protocol data with the hybrid automatic repeat request acknowledgement feedback.

22. The user equipment of claim 21, wherein the scheduling request for the acknowledgement for the transport protocol data is scheduled before the hybrid automatic repeat request acknowledgement feedback is suppressed.

23. The user equipment of claim 21, wherein the scheduling request for the acknowledgement for the transport protocol data is scheduled after the hybrid automatic repeat request acknowledgement feedback is suppressed and before expiration of a timer.

24. A non-transitory computer-readable medium storing one or more instructions for wireless communication, the one or more instructions comprising:
one or more instructions that, when executed by one or more processors of a user equipment, cause the one or more processors to:
receive a physical layer downlink message including transport protocol data;
multiplex a scheduling request for an acknowledgement for the transport protocol data with hybrid automatic repeat request acknowledgement feedback for the physical layer downlink message; and
transmit the scheduling request for the acknowledgement for the transport protocol data with the hybrid automatic repeat request acknowledgement feedback.

25. The non-transitory computer-readable medium of claim 24, wherein the one or more instructions, when executed by the one or more processors, further cause the one or more processors to:
determine that the scheduling request for the acknowledgement for the transport protocol data is available for multiplexing with the hybrid automatic repeat request acknowledgement feedback,
wherein the multiplexing is based at least in part on the determining that, the scheduling request for the acknowledgement for the transport protocol data is available for multiplexing with the hybrid automatic repeat request acknowledgement feedback, and
wherein the transmitting is based at least in part on the determining that the scheduling request for the acknowledgement for the transport protocol data with the hybrid automatic repeat request acknowledgement feedback.

26. The non-transitory computer-readable medium of claim 25, wherein the one or more instructions, that cause the one or more processors to determine that the scheduling request for the acknowledgement for the transport protocol data is available for multiplexing with the hybrid automatic repeat request acknowledgement feedback, cause the one or more processors to:
determine that the scheduling request for the acknowledgement for the transport protocol data is available for multiplexing with the hybrid automatic repeat request acknowledgement feedback during a threshold period of time.

27. The non-transitory computer-readable medium of claim 24, wherein transmission of the hybrid automatic repeat request acknowledgement feedback is suppressed for at least a threshold period of time to multiplex the scheduling request for the acknowledgement for the transport protocol data with the hybrid automatic repeat request acknowledgement feedback.

28. The non-transitory computer-readable medium of claim 27, wherein the scheduling request for the acknowledgement for the transport protocol data is scheduled before the hybrid automatic repeat request acknowledgement feedback is suppressed.

29. The non-transitory computer-readable medium of claim 27, wherein the scheduling request for the acknowledgement for the transport protocol data is scheduled after the hybrid automatic repeat request acknowledgement feedback is suppressed and before expiration of a timer.

30. The non-transitory computer-readable medium of claim 24, wherein the scheduling request for the acknowledgement for the transport protocol data is transmitted with the hybrid automatic repeat request acknowledgement feedback using a resource scheduled for the scheduling request for the acknowledgement for the transport protocol data.
